(19) United States
(12) Patent Application Publication
(10) Pub. No.: US 2025/0388161 A1
(43) Pub. Date: Dec. 25, 2025

(54) Vehicle Seat Massage System Including Noise Reduction

(71) Applicant: Nissan North America, Inc., Franklin, TN (US)

(72) Inventor: Brian Ziola, Commerce Township, MI (US)

(21) Appl. No.: 18/753,851

(22) Filed: Jun. 25, 2024

(51) Int. Cl. B60N 2/90; A61H 9/00

(52) U.S. Cl. CPC B60N 2/976; A61H 9/0078; A61H 2201/0149; A61H 2201/0169; A61H 2201/1238; A61H 2201/1409; A61H 2201/5002; A61H 2201/5007; A61H 2203/0431

(57) ABSTRACT

A vehicle seat that includes at least one airbag and a regulator that is configured to control inflation and deflation thereof. The regulator includes an electronic control unit (ECU) that is in fluid communication with the at least one airbag and a silencer that is in fluid communication with the ECU and which is configured to reduce noise during deflation of the at least one airbag.

### TECHNICAL FIELD

The present application relates to noise reduction during the operation of a massage system in a vehicle seat.

### BACKGROUND

In an effort to increase passenger comfort, modern vehicle seats often include a massage system (e.g., located in a lumbar region thereof), which typically applies and varies pressure by inflating and deflating one or more airbags (or the like). During deflation, however, the air being exhausted from the system can create a perceptible and objectionable sound.

In order to address this issue, the present disclosure provides a massage system for a vehicle seat that includes a silencer in order to reduce noise.

### SUMMARY

In one aspect of the present disclosure, a vehicle seat is disclosed that includes: a seat body, which defines a passenger seating area; at least one airbag that is supported by the seat body; and a regulator that is supported by the seat body and which is configured to control inflation and deflation of the at least one airbag. The regulator includes: a pump; an electronic control unit (ECU) that is in fluid communication and electrical communication with the pump; a first hose that facilitates airflow from the pump into the ECU; at least one second hose that facilitates airflow between the ECU and the at least one airbag; a silencer that is in fluid communication with the ECU such that air flows from the at least one airbag through the ECU and into the silencer during deflation of the at least one airbag to thereby reduce noise; and at least one third hose that facilitates airflow from the ECU into the silencer.

In certain embodiments, the at least one airbag may be oriented in a generally forward direction, and the regulator may be oriented in a generally rearward direction.

In certain embodiments, the ECU may be configured such that air flows from the ECU and into the at least one airbag in a first direction, and such that air flows from the ECU and into the silencer in a second direction that is generally opposite to the first direction.

In certain embodiments, the at least one airbag may include a plurality of airbags.

In certain embodiments, the at least one second hose may include a plurality of second hoses that correspond in number to the plurality of airbags.

In certain embodiments, the at least one third hose may include a plurality of third hoses that correspond in number to the plurality of airbags.

In certain embodiments, the regulator may further include a manifold that is in fluid communication with the plurality of third hoses and the silencer.

In certain embodiments, the manifold may be configured to collect and direct airflow from the plurality of third hoses into the silencer.

In certain embodiments, the silencer may include an exhaust port.

In certain embodiments, the silencer may be configured to direct airflow away from the passenger seating area during deflation of the at least one airbag.

In certain embodiments, the silencer may be configured such that the exhaust port is oriented in a generally downward direction.

In certain embodiments, the regulator may further include an outlet tube that extends from the exhaust port and which terminates within the seat body.

In another aspect of the present disclosure, a vehicle seat is disclosed that includes at least one airbag and a regulator that is configured to control inflation and deflation thereof. The regulator includes an ECU that is in fluid communication with the at least one airbag and a silencer that is in fluid communication with the ECU, wherein the silencer is configured to reduce noise during deflation of the at least one airbag.

In certain embodiments, the ECU may be configured such that air flows from the ECU and into the at least one airbag in a first direction, and such that air flows from the ECU and into the silencer in a second direction that is generally opposite to the first direction.

In certain embodiments, the at least one airbag may include a plurality of airbags.

In certain embodiments, the regulator may further include a plurality of first hoses that facilitate airflow between the ECU and the plurality of airbags.

In certain embodiments, the regulator may further include a plurality of second hoses that facilitate airflow from the ECU into the silencer.

In certain embodiments, the regulator may further include a manifold that is in fluid communication with the plurality of second hoses and the silencer.

In certain embodiments, the manifold may be configured to direct airflow from the plurality of second hoses into the silencer.

In certain embodiments, the silencer may include an exhaust port that is oriented in a generally downward direction such that air is directed away from a passenger in the vehicle seat during deflation of the at least one airbag.

In another aspect of the present disclosure, a method of operating a massage system in a vehicle seat is disclosed. The method includes: engaging a pump; directing airflow from the pump into an ECU; directing airflow from the ECU into at least one airbag to thereby inflate the at least one airbag; disengaging the pump; directing airflow from the at least one airbag into the ECU to thereby deflate the at least one airbag; and directing airflow from the ECU into a silencer to thereby reduce noise during deflation of the at least one airbag.

In certain embodiments, directing airflow from the pump into the ECU may include opening a first valve in the ECU, thereby permitting airflow from the ECU into the at least one airbag.

In certain embodiments, directing airflow from the pump into the ECU may include closing a second valve in the ECU, thereby inhibiting airflow from the ECU into the silencer.

In certain embodiments, directing airflow from the ECU into the silencer may include opening the second valve.

In certain embodiments, the method may further include directing airflow from the ECU into a manifold that is positioned between the ECU and the silencer.

In certain embodiments, the method may further include exhausting air from the silencer in a generally downward direction.

### BRIEF DESCRIPTION OF THE DRAWINGS

According to common practice, the various features of the drawings may not be to-scale, and the dimensions of the various features may be arbitrarily expanded or reduced. Additionally, in the interest of clarity, certain components, elements, and/or features may be omitted from certain drawings in the interest of clarity.

FIG. 1 is a front, perspective view of a vehicle seat according to the principles of the present disclosure, which includes at least one airbag and a regulator that is configured to control inflation and deflation thereof.

FIG. 2 is a rear, perspective view of the vehicle seat seen in FIG. 1.

FIG. 3 is a rear, plan view of the regulator.

### DETAILED DESCRIPTION

The present disclosure describes a vehicle seat with an integrated massage system that includes (one or more) at least one airbag and a regulator that controls inflation and deflation thereof. The regulator includes: a pump; an ECU that is in fluid and electrical communication with the pump; and a silencer that is in fluid communication with the ECU such that air flows from the at least one airbag through the ECU and into the silencer during deflation of the at least one airbag, thereby reducing noise.

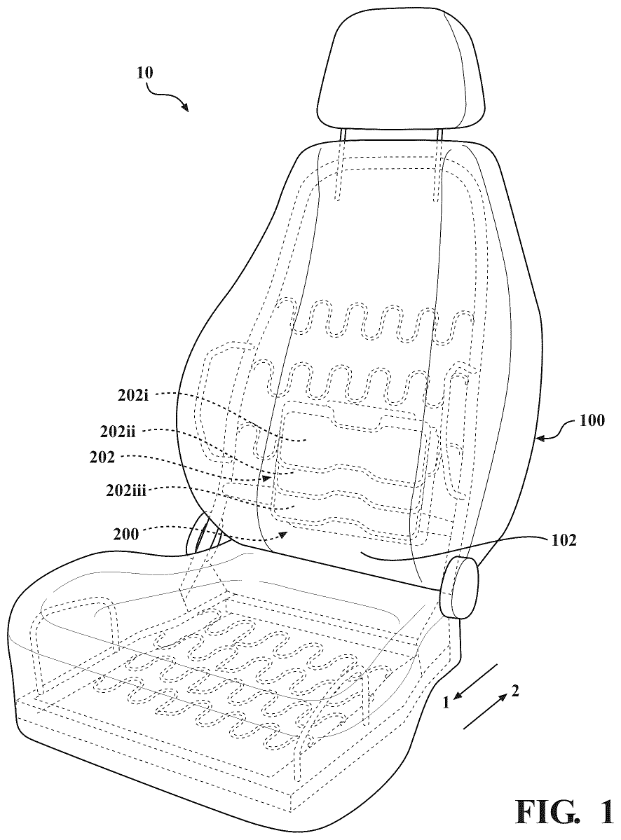

With reference to FIGS. 1-3, a vehicle seat 10 is disclosed that includes a seat body 100, which defines a passenger seating area 102, and an integrated massage system 200, which is connected (secured) to (or otherwise supported by, integrated into) the seat body 100. Although generally illustrated and described in the context of a passenger vehicle, it should be appreciated that the vehicle seat 10 described herein may be configured for use with a wide variety of vehicles (e.g., trucks, SUVs, vans, buses, boats, airplanes, trains, etc.).

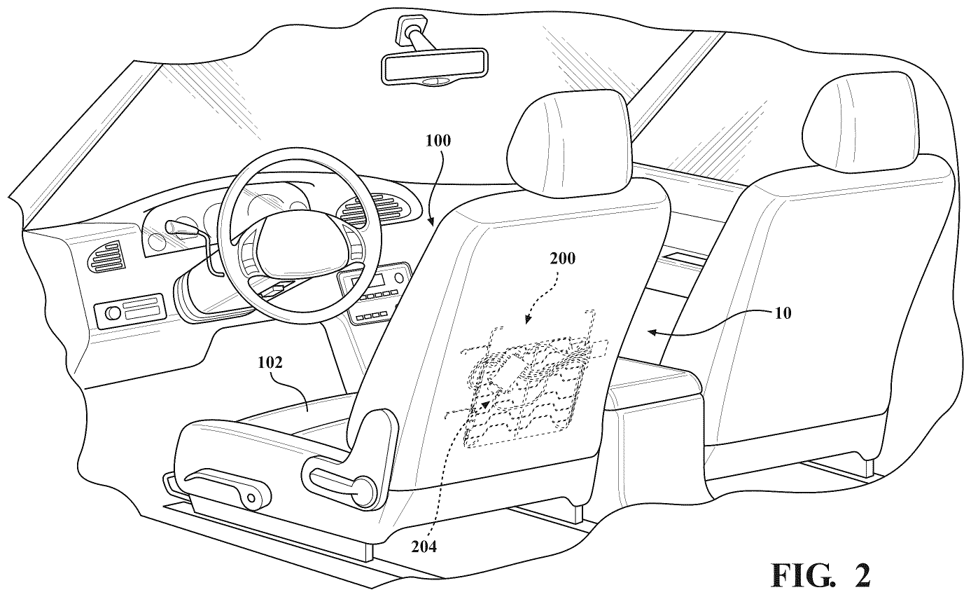

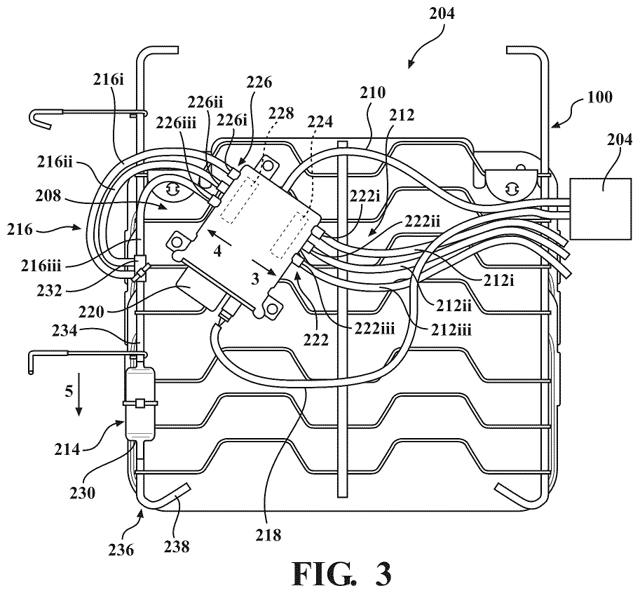

The massage system 200 includes (one or more) at least one airbag 202 (FIG. 1) and a regulator 204 (FIGS. 2, 3), each of which is connected (secured) to (or otherwise supported by) the seat body 100. Although the massage system 200 is illustrated in a lumbar region of the vehicle seat 10 in the illustrated embodiment, it is envisioned that the massage system 200 may be positioned in any suitable location(s).

The airbag(s) 202 are located internally within the vehicle seat 10 and are oriented (faces) in a generally forward direction 1 (FIG. 1). The airbag(s) 202 are subject to inflation and deflation upon the communication of air (or other such suitable fluid(s)) into and out of the airbag(s) 202, which is controlled by the regulator 204, as described in further detail below.

In the illustrated embodiment, the massage system 200 includes a plurality of airbags 202. More specifically, the massage system 200 includes three airbags 202i, 202ii, 202iii. Embodiments in which the specific number of airbags 202 may be increased or decreased are also envisioned herein, however, and would not be beyond the scope of the present disclosure.

The regulator 204 is located internally within the vehicle seat 10 and is oriented (faces) in a generally rearward direction 2 (FIG. 1). The regulator 204 is in fluid communication with the airbag(s) 202 and is configured to control inflation and deflation thereof by directing airflow through the massage system 200. As seen in FIG. 3, the regulator 204 includes: a pump 206; an ECU 208; a (first) hose 210, which facilitates airflow from the pump 206 into the ECU 208; (one or more) at least one (second) hose 212, which facilitates airflow between the ECU 208 and the airbag(s) 202; a silencer 214; and (one or more) at least one (third) hose 216, which facilitates airflow from the ECU 208 into the silencer 214.

The pump 206 is connected (secured) to (or otherwise supported by) the seat body 100 and draws in air from the ambient, which is directed into the ECU 208 via the hose 210. Operation of the pump 206 is controlled by the ECU 208, which relays electrical signal thereto upon activation of the massage system 200, as described in further detail below.

The ECU 208 is in fluid and electrical communication with the pump 206. More specifically, the ECU 208 is fluidly connected to the pump 206 via the hose 210, which facilitates the flow of air from the pump 206 into the ECU 208, and electrically connected to the pump 206 via an electrical connector 218 (e.g., (one or more) at least one cable, wire, etc.).

The ECU 208 includes: a harness port 220, which allows for connection of the ECU 208 to the vehicle in order to facilitate the transmission of electrical signals therebetween (e.g., to activate and deactivate the massage system 200, run a massage sequence, etc.); (one or more) at least one (first) port 222, which is connected to the hose(s) 212; a (first) valve 224, which facilitates (bidirectional) air flow between the ECU 208 and the airbag(s) 202 (i.e., through the port(s) 222); (one or more) at least one (second) port 226, which is connected to the hose(s) 216; and a (second) valve 228, which facilitates (unidirectional) air flow from the ECU 208 into the silencer 214 (i.e., through the port(s) 226).

As seen in FIG. 3, the ECU 208 is configured such that the ports 222, 226 are oriented in generally opposite directions. More specifically, during operation of the massage system 200, air flows from the ECU 208 through the valve 224 and the port(s) 222 and into the airbag(s) 202 in a first direction 3, and air flows from the ECU 208 through the valve 228 and the port(s) 226 and into the silencer 214 in a second direction 4.

The ports 222, 226 and the hoses 212, 216 each correspond in number to the airbag(s) 202. As such, in the illustrated embodiment, the ECU 208 includes a plurality of ports 222, 226 and a plurality of hoses 212, 216. More specifically, the massage system 200 includes three ports 2221, 222ii, 222iii, three ports 226i, 226ii, 226iii, three hoses 212i, 212ii, 212iii, and three hoses 216i, 216ii, 216iii. Embodiments in which the specific number of ports 222, 226 and hoses 212, 216 may be increased or decreased are also envisioned herein (i.e., depending upon the specific number of airbag(s) 202), however, and would not be beyond the scope of the present disclosure.

The silencer 214 is in fluid communication with the ECU 208 such that, during use of the massage system 200, air flows from the airbag(s) 202, through the ECU 208, and into the silencer 214. The silencer 214 includes an exhaust port 230 and is configured to reduce noise during deflation of the airbag(s) 202. More specifically, the silencer 214 receives and slows airflow, redirecting and distributing air within the silencer 214 (e.g., via internal baffle(s)), and allows for expansion thereof prior to being exhausted through the exhaust port 230.

As seen in FIG. 3, the silencer 214 is configured such that the exhaust port 230 and, thus, air exhausting from the silencer 214 during deflation of the airbag(s) 202, is directed away from the passenger seating area 102 (FIG. 1) and the passenger in the vehicle seat 10. More specifically, the silencer 214 is configured such that the exhaust port 230 is oriented in a generally downward direction 5.

In the illustrated embodiment, the regulator 204 further includes a manifold (coupling) 232, which is positioned (located) between the hoses 216 and the silencer 214 and is in fluid communication therewith. The manifold 232 collects and directs airflow from the hoses 216 into the silencer 214, which eliminates the need for multiple silencers 214 (i.e., one for each hose 216), thereby simplifying the construction and installation of the regulator 204 and reducing the overall cost of the massage system 200 and the vehicle seat 10.

In the illustrated embodiment, the silencer 214 is in fluid communication with the manifold 232 via a (fourth) hose 234, which extends therebetween. Embodiments that are devoid of the hose 234 (i.e., embodiments in which the manifold 232 is directly connected to the silencer 214) are also envisioned herein (e.g., depending upon the configuration of the vehicle seat 10, the configuration of the silencer 214, the configuration of the manifold 232, etc.), however, and would not be beyond the scope of the present disclosure.

As seen in FIG. 3, in the illustrated embodiment, the regulator 204 further includes a (fifth) hose 236 (e.g., an outlet tube 238), which is in fluid communication with the silencer 214 (i.e., the exhaust port 230). The hose 236 terminates within the seat body 100 and collects and directs air from the silencer 214 away from the passenger seating area 102 (FIG. 1) and the passenger in the vehicle seat 10, which increases the separation therebetween in order to further reduce noise during deflation of the airbag(s) 202.

With continued reference to FIGS. 1-3, use and operation of the massage system 200 will be discussed, during which, the airbags 202 are inflated and deflated to thereby massage the passenger in the vehicle seat 10. In certain methods of use, it is envisioned that inflation and deflation of the airbag(s) 202 may performed according to a predetermined sequence, which may be programmed into the ECU 208, in order to vary the applied pressure.

Initially, the massage system 200 (FIGS. 1, 2) is activated (engaged) (e.g., via a switch on the vehicle seat 10 or the vehicle console, via the entertainment screen, etc.). Upon activation, a signal is transmitted to the pump 206 (FIG. 3) via the ECU 208, which engages the pump 206, opens the valve 224, thereby permitting (facilitating) airflow from the ECU 208 into the airbag(s) 202, and closes the valve 228, thereby inhibiting (if not entirely preventing) airflow from the ECU 208 into the silencer 214.

Upon engagement, the pump 206 draws in ambient air, which is directed to the ECU 208 via the hose 210. Upon entering the ECU 208, the air is directed through the valve 224 and the ports 222 (i.e., in the direction 3) into the airbag(s) 202 via the hoses 212, which causes inflation thereof.

In order to deflate the airbag(s) 202, a signal is transmitted to the pump 206 via the ECU 208, which disengages the pump 206, closes the valve 224, and opens the valve 228, thereby directing air from the airbag(s) 202, into the ECU 208, through the valve 228 and the ports 226 (i.e., in the direction 4) into the manifold 232 via the hoses 216, and into the silencer 214 via the hose 234. Upon exiting the silencer 214, the air is directed through the exhaust port 230 in the generally downward direction 5 (FIG. 3).

Persons skilled in the art will understand that the various embodiments of the disclosure described herein and shown in the accompanying figures constitute non-limiting examples, and that additional components and features may be added to any of the embodiments discussed herein above without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

Use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (i.e., an angle that lies within the range of (approximately) 135° to (approximately) 225°) and the term “generally orthogonal” should be understood as referring to configurations in with the pertinent components are oriented so as to define an angle therebetween that is equal to 90°±25% (i.e., an angle that lies within the range of (approximately) 67.5° to (approximately) 112.5°). The term “generally parallel” should thus be understood as referring to encompass configurations in which the pertinent components are arranged in parallel relation, and the term “generally orthogonal” should thus be understood as referring to encompass configurations in which the pertinent components are arranged in orthogonal relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A vehicle seat comprising:
a seat body defining a passenger seating area;
at least one airbag supported by the seat body; and
a regulator supported by the seat body and configured to control inflation and deflation of the at least one airbag, wherein the regulator includes:
a pump;
an electronic control unit (ECU) in fluid communication and electrical communication with the pump;
a first hose facilitating airflow from the pump into the ECU;
at least one second hose facilitating airflow between the ECU and the at least one airbag;
a silencer in fluid communication with the ECU such that air flows from the at least one airbag through the ECU and into the silencer during deflation of the at least one airbag to thereby reduce noise; and
at least one third hose facilitating airflow from the ECU into the silencer.

2. The vehicle seat of claim 1, wherein the at least one airbag is oriented in a generally forward direction, and the regulator is oriented in a generally rearward direction.

3. The vehicle seat of claim 1, wherein the ECU is configured such that air flows from the ECU and into the at least one airbag in a first direction, and air flows from the ECU and into the silencer in a second direction generally opposite to the first direction.

4. The vehicle seat of claim 1, wherein the at least one airbag includes a plurality of airbags.

5. The vehicle seat of claim 4, wherein the at least one second hose includes a plurality of second hoses corresponding in number to the plurality of airbags.

6. The vehicle seat of claim 5, wherein the at least one third hose includes a plurality of third hoses corresponding in number to the plurality of airbags.

7. The vehicle seat of claim 6, wherein the regulator further includes:
a manifold in fluid communication with the plurality of third hoses and the silencer, wherein the manifold is configured to collect and direct airflow from the plurality of third hoses into the silencer.

8. The vehicle seat of claim 1, wherein the silencer includes an exhaust port and is configured to direct airflow away from the passenger seating area during deflation of the at least one airbag.

9. The vehicle seat of claim 8, wherein the silencer is configured such that the exhaust port is oriented in a generally downward direction.

10. The vehicle seat of claim 9, wherein the regulator further includes:
an outlet tube extending from the exhaust port and terminating within the seat body.

11. A vehicle seat comprising:
at least one airbag; and
a regulator configured to control inflation and deflation of the at least one airbag, wherein the regulator includes:
an electronic control unit (ECU) in fluid communication with the at least one airbag; and
a silencer in fluid communication with the ECU, wherein the silencer is configured to reduce noise during deflation of the at least one airbag.

12. The vehicle seat of claim 11, wherein the ECU is configured such that air flows from the ECU and into the at least one airbag in a first direction, and air flows from the ECU and into the silencer in a second direction generally opposite to the first direction.

13. The vehicle seat of claim 11, wherein the at least one airbag includes a plurality of airbags, and the regulator further includes:
a plurality of first hoses facilitating airflow between the ECU and the plurality of airbags.

14. The vehicle seat of claim 13, wherein the regulator further includes:
a plurality of second hoses facilitating airflow from the ECU into the silencer; and
a manifold in fluid communication with the plurality of second hoses and the silencer, wherein the manifold is configured to direct airflow from the plurality of second hoses into the silencer.

15. The vehicle seat of claim 11, wherein the silencer includes an exhaust port oriented in a generally downward direction such that air is directed away from a passenger in the vehicle seat during deflation of the at least one airbag.

16. A method of operating a massage system in a vehicle seat, the method comprising:
engaging a pump;
directing airflow from the pump into an electronic control unit (ECU);
directing airflow from the ECU into at least one airbag to thereby inflate the at least one airbag;
disengaging the pump;
directing airflow from the at least one airbag into the ECU to thereby deflate the at least one airbag; and
directing airflow from the ECU into a silencer to thereby reduce noise during deflation of the at least one airbag.

17. The method of claim 16, wherein directing airflow from the pump into the ECU includes:
opening a first valve in the ECU, thereby permitting airflow from the ECU into the at least one airbag; and
closing a second valve in the ECU, thereby inhibiting airflow from the ECU into the silencer.

18. The method of claim 17, wherein directing airflow from the ECU into the silencer includes opening the second valve.

19. The method of claim 16, further including:
directing airflow from the ECU into a manifold positioned between the ECU and the silencer.

20. The method of claim 16, further including:
exhausting air from the silencer in a generally downward direction.
